(19) United States
(12) Patent Application Publication
(10) Pub. No.: US 2017/0168512 A1
(43) Pub. Date: Jun. 15, 2017

(54) OUTPUT VOLTAGE STABILIZING CIRCUIT OF POWER SUPPLY

(71) Applicants: Le Holdings (Beijing) Co., Ltd., Beijing (CN); LE SHI ZHI XIN ELECTRONIC TECHNOLOGY (TIANJIN) LIMITED, Beijing (CN)

(72) Inventor: Wen Zhang, Beijing (CN)

(21) Appl. No.: 15/246,934

(22) Filed: Aug. 25, 2016

Related U.S. Application Data
(63) Continuation of application No. PCT/CN2016/088462, filed on Jul. 4, 2016.

(30) Foreign Application Priority Data
Dec. 14, 2015 (CN) 201521048699.5

(51) Int. Cl. G05F 1/46

(52) U.S. Cl. CPC G05F 1/46

(57) ABSTRACT

The present disclosure provides an output voltage stabilizing circuit of a power supply, including: a compensation resistor, a voltage dividing circuit and a power driving chip; one end of the compensation resistor is connected with a load output end of the power supply, the other end of the compensation resistor is connected with a first end of the voltage dividing circuit, a second end of the voltage dividing circuit is connected with a voltage feedback pin of the power driving chip, and a third end of the voltage dividing circuit is grounded. The compensation resistor feeds back the voltage of the load output end of the power supply to the voltage feedback pin of the power driving chip via the voltage dividing circuit, and then the power driving chip adjusts the output voltage pin thereof, so that the output voltage of the power supply is kept stable.

### CROSS-REFERENCE TO RELATED APPLICATIONS

The present disclosure is a continuation of International Application No. PCT/CN2016/088462, filed on Jul. 4, 2016, which is based upon and claims priority to Chinese Patent Application No. 201521048699.5, filed on Dec. 14, 2015, the entire contents of which are incorporated herein by reference.

### TECHNICAL FIELD

The present disclosure relates to the technical field of power circuit design, and specifically, relates to an output voltage stabilizing circuit of a power supply.

### BACKGROUND

Any electric appliance can't work without power, but a voltage input to some electric appliances or devices is not of normal mains supply or direct current due to inherent reasons, so the existing direct current voltage or alternating current voltage generally needs to be converted into the input voltage required for the devices by a power conversion module.

DC-DC power application is general, e.g., a 12V direct current voltage is converted into a 5V direct current voltage or a 3.3V direct current voltage, etc. At present, a feedback voltage of a DC-DC circuit is generally taken after an output filter capacitor. Since a long power cable is needed when power is supplied to an external device, the output voltage may be instable when the load of a connecting device changes fast. However, the changes of voltage of a load end generally cannot be acquired from the feedback voltage taken after the output filter capacitor. At the moment, if the output voltage has a high overshoot and the voltage is too high, the device connected with the power module may be damaged.

### SUMMARY

In view of the technical problems in the prior art, the embodiments of the present disclosure provide an output voltage stabilizing circuit of a power supply for outputting a stable voltage.

The present disclosure provides an output voltage stabilizing circuit of a power supply, including: a compensation resistor, a voltage dividing circuit and a power driving chip;
one end of the compensation resistor is connected with a load output end of the power supply, the other end of the compensation resistor is connected with a first end of the voltage dividing circuit, a second end of the voltage dividing circuit is connected with a voltage feedback pin of the power driving chip, and a third end of the voltage dividing circuit is grounded.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a circuit diagram of an output voltage stabilizing circuit of a power supply provided by some embodiments of the present disclosure;

FIG. 2 is a circuit diagram of an output voltage stabilizing circuit of a power supply provided by some embodiments of the present disclosure.

### DETAILED DESCRIPTION

To make the objects, technical solutions and advantages of the embodiments of the present disclosure clearer, a clear and complete description of the technical solutions in the embodiments of the present disclosure will be given below, in combination with the accompanying drawings in the embodiments of the present disclosure. Apparently, the embodiments described are a part, but not all, of the embodiments of the present disclosure. All of other embodiments obtained by those of ordinary skill in the art based on the embodiments of the present disclosure without creative work fall into the protection scope of the present disclosure.

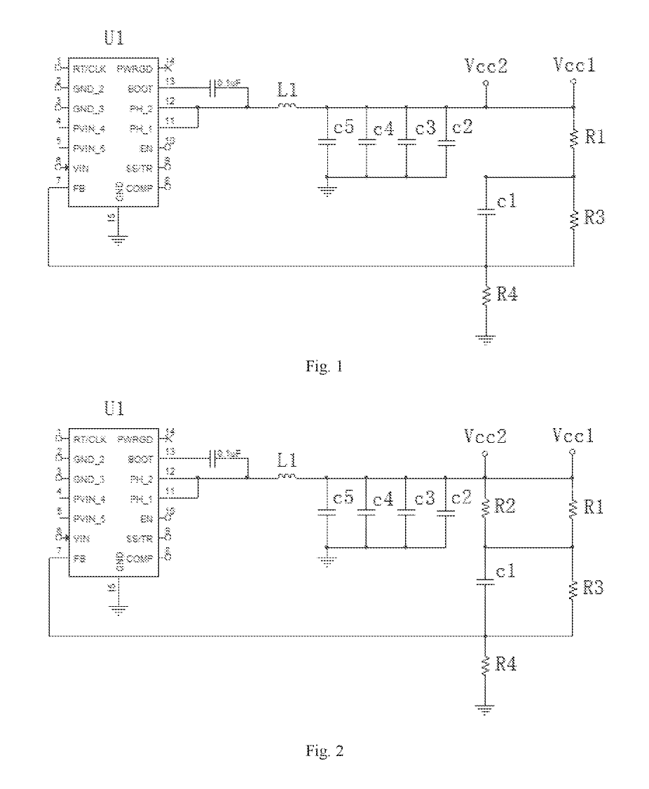

FIG. 1 shows a circuit diagram of an output voltage stabilizing circuit of a power supply provided by an embodiment of the present disclosure. As shown in FIG. 1, the output voltage stabilizing circuit of a power supply includes a first compensation resistor R1, a voltage dividing circuit and a power driving chip U1;
one end of the first compensation resistor R1 is connected with a load output end Vcc1 of the power supply, the other end of the first compensation resistor R1 is connected with a first end a of the voltage dividing circuit, a second end b of the voltage dividing circuit is connected with a voltage feedback pin FB of the power driving chip U1, and a third end c of the voltage dividing circuit is grounded.

According to the above circuit, the compensation resistor, which is arranged at the load output end of the power supply, feeds back the voltage of the load output end of the power supply to the voltage feedback pin of the power driving chip via the voltage dividing circuit, and then the power driving chip adjusts the output voltage pin thereof according to the voltage of the voltage feedback pin, so that the output voltage of the power supply is kept stable and normal operation of a device externally connected to the output voltage is ensured.

In at least one embodiment, the voltage dividing circuit includes a first voltage dividing resistor R3 and a second voltage dividing resistor R4;
one end of the first voltage dividing resistor R3 is connected with the compensation resistor R1 as the first end a of the voltage dividing circuit, the other end of the first voltage dividing resistor R3 is connected with the voltage feedback pin FB of the power driving chip as the second end b of the voltage dividing circuit, one end of the second voltage dividing resistor R4 is connected with the second end b, and the other end of the second voltage dividing resistor R4 is grounded.

The voltage dividing circuit further includes a first filter capacitor c1, which is connected in parallel to the first voltage dividing resistor R3. The first filter capacitor c1 is used for filtering the output voltage, thus preventing the FB voltage of the chip from being too high due to a voltage peak or spike to damage the chip.

It can be understood that the resistances of the first voltage dividing resistor R3 and the second voltage dividing resistor R4 can be adjusted according to the output voltage, so that the voltage to the voltage feedback pin FB of the power driving chip U1 after voltage division is the voltage of the pin, and the voltage is generally 0.7V. Of course, different chips may have different voltage values, and this embodiment is not limited thereto.

In order to filter the peak of the output voltage, the circuit in this embodiment further includes an output filter capacitor, one end of the output filter capacitor is connected with a voltage output end Vcc2 of the power supply, and the other end of the output filter capacitor is grounded. Generally, a plurality of output filter capacitors are adopted, such as c2, c3, c4 and c5 shown in FIG. 1.

The circuit further includes an inductor L1, which is connected between the output filter capacitor c5 and an output voltage pin PH_2 of the power driving chip.

In another implementable way, as shown in FIG. 2, when the leads of the external device end (i.e., the load output end Vcc1) and the voltage output end Vcc2 are short and the load change of the external device is not obvious, the voltage conditions of the output ends can also be fed back in time without said first compensation resistor R1, that is, the circuit may further include a second compensation resistor R2, one end of the second compensation resistor R2 is arranged at the rear end of the output filter capacitor, and the other end of second compensation resistor is connected with the first end a of the voltage dividing circuit. It can be understood that in order to adapt to different conditions, in this embodiment the circuit can be designed to include both the first compensation resistor R1 and the second compensation resistor R2, and the positions of R1 and R2 are also reserved during PCB wiring, but in the power debugging process, only one of R1 and R2 needs to be used. The resistors can be selected according to the specific debugging condition, and are not limited in this embodiment.

The device embodiments described above are merely schematic, wherein the units illustrated as separate components may be or may not be physically separated, and the components displayed as units may be or may not be physical units, that is to say, the components may be positioned at one place or may also be distributed on a plurality of network units. The objects of the solutions of the embodiments may be achieved by selecting part of or all of the modules according to actual needs. Those of ordinary skill in the art can understand and implement the embodiments without creative effort.

Finally, it should be noted that the aforementioned embodiments are merely used for illustrating the technical solutions of the present disclosure, rather than limiting the present disclosure; though the present disclosure is illustrated in detail with reference to the aforementioned embodiments, it should be understood by those of ordinary skill in the art that modifications may still be made to the technical solutions disclosed in the aforementioned embodiments, or equivalent substitutions may be made to part of the technical features thereof; and these modifications or substitutions do not make the nature of the corresponding technical solutions depart from the spirit and scope of the technical solutions of the embodiments of the present disclosure.

What is claimed is:

1. An output voltage stabilizing circuit of a power supply, comprising: a compensation resistor, a voltage dividing circuit and a power driving chip;
wherein one end of the compensation resistor is connected with a load output end of the power supply, the other end of the compensation resistor is connected with a first end of the voltage dividing circuit, a second end of the voltage dividing circuit is connected with a voltage feedback pin of the power driving chip, and a third end of the voltage dividing circuit is grounded.

2. The circuit according to claim 1, wherein the voltage dividing circuit comprises a first voltage dividing resistor and a second voltage dividing resistor;
one end of the first voltage dividing resistor is connected with the compensation resistor as the first end of the voltage dividing circuit, the other end of the first voltage dividing resistor is connected with the voltage feedback pin of the power driving chip as the second end of the voltage dividing circuit, one end of the second voltage dividing resistor is connected with the second end, and the other end of the second voltage dividing resistor is grounded.

3. The circuit according to claim 2, wherein the voltage dividing circuit further comprises a first filter capacitor, which is connected in parallel to the first voltage dividing resistor.

4. The circuit according to claim 1, wherein the circuit further comprises an output filter capacitor, one end of the output filter capacitor is connected with the voltage output end of the power supply, and the other end of the output filter capacitor is grounded.

5. The circuit according to claim 4, wherein a plurality of output filter capacitors are adopted.

6. The circuit according to claim 4, wherein the circuit further comprises an inductor, which is connected between the output filter capacitor and an output voltage pin of the power driving chip.
